(19) United States
(12) Patent Application Publication
(10) Pub. No.: US 2008/0035733 A1
(43) Pub. Date: Feb. 14, 2008

(54) Illumination without hot spots in field of view of imaging reader

(76) Inventors: Igor Vinogradov, Bay Shore, NY (US); Mark Drzymala, Commack, NY (US)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 11/496,308

(22) Filed: Jul. 31, 2006

(51) Int. Cl. G06K 7/10

(52) U.S. Cl. 235/462.42; 235/462.41

(57) ABSTRACT

A target is illuminated with illumination light without creating hot spots in a field of view of a solid-state imager of an imaging reader to improve reader performance.

### DESCRIPTION OF THE RELATED ART

Flat bed laser readers, also known as horizontal slot scanners, have been used to electro-optically read one-dimensional bar code symbols, particularly of the Universal Product Code (UPC) type, at a point-of-transaction workstation in supermarkets, warehouse clubs, department stores, and other kinds of retailers for many years. As exemplified by U.S. Pat. No. 5,059,799; U.S. Pat. No. 5,124,539 and U.S. Pat. No. 5,200,599, a single, horizontal window is set flush with, and built into, a horizontal countertop of the workstation. Products to be purchased bear an identifying symbol and are typically slid or swiped across the horizontal window through which a multitude of scan lines in a scan pattern is projected in a generally upward direction. Each scan line is generated by sweeping a laser beam from a laser. When at least one of the scan lines sweeps over a symbol associated with a product, the symbol is processed and read.

Instead of, or in addition to, a horizontal slot scanner, it is known to provide a vertical slot scanner, which is typically a portable reader placed on the countertop such that its window is generally vertical and faces an operator at the workstation. The generally vertical window is oriented perpendicularly to the horizontal window, or is slightly rearwardly inclined. A scan pattern generator within the vertical slot scanner also sweeps a laser beam and projects a multitude of scan lines in a scan pattern in a generally outward direction through the vertical window toward the operator. The operator slides or swipes the products past either window from right to left, or from left to right, in a “swipe” mode. Alternatively, the operator merely presents the symbol on the product to the center of either window in a “presentation” mode. The choice depends on operator preference or on the layout of the workstation.

These point-of-transaction workstations have been long used for processing transactions involving products associated with one-dimensional symbols each having a row of bars and spaces spaced apart along one direction, and for processing two-dimensional symbols, such as Code 39, as well. Code 39 introduced the concept of vertically stacking a plurality of rows of bar and space patterns in a single symbol. The structure of Code 39 is described in U.S. Pat. No. 4,794,239. Another two-dimensional code structure for increasing the amount of data that can be represented or stored on a given amount of surface area is known as PDF417 and is described in U.S. Pat. No. 5,304,786.

Both one- and two-dimensional symbols can also be read by employing solid-state imagers, instead of moving a laser beam across the symbols in a scan pattern. For example, an image sensor device may be employed which has a one- or two-dimensional array of cells or photosensors which correspond to image elements or pixels in a field of view of the device. Such an image sensor device may include a one- or two-dimensional charge coupled device (CCD) or a complementary metal oxide semiconductor (CMOS) device and associated circuits for producing electronic signals corresponding to a one- or two-dimensional array of pixel information over a field of view.

It is therefore known to use a solid-state device for capturing a monochrome image of a symbol as, for example, disclosed in U.S. Pat. No. 5,703,349. It is also known to use a solid-state device with multiple buried channels for capturing a full color image of a target as, for example, disclosed in U.S. Pat. No. 4,613,895. It is common to provide a two-dimensional CCD with a 640×480 resolution commonly found in VGA monitors, although other resolution sizes are possible.

To acquire an image of a symbol under low ambient light or in a dark environment, an illuminator is employed to illuminate the symbol during image capture. The illuminator typically includes a plurality of light sources, such as light emitting diodes (LEDs), within the reader. The illumination light from each LED is incident on, and passes through, the window of the reader en route to the symbol to be illuminated. However, a portion of each illumination light incident on the window may be reflected therefrom back towards, and captured by, the imager thereby creating an area or zone of high intensity light, hereinafter a “hot spot”, within the field of view of the imager. Each LED creates its own hot spot. Basically, each hot spot is a ghost image of a respective LED. These ghost images are superimposed over the image of the symbol and often compromise decoding and degrade reader performance.

### SUMMARY OF THE INVENTION

One feature of the present invention resides, briefly stated, in a reader for, and a method of, electro-optically reading indicia, especially one- or two-dimensional symbols. The reader could be embodied as a stationary or portable point-of-transaction workstation having a planar window, or as a handheld reader having a planar window. In the case of the workstation, the symbol is swiped past, or presented to, the window and, in the case of the handheld reader, the reader itself is moved and aimed at the symbol. In the preferred embodiment, the workstation is installed in a retail establishment, such as a supermarket.

A one- or two-dimensional, solid-state imager is mounted in the reader, and includes an array of image sensors operative for capturing light from a one- or two-dimensional symbol or target through the window over a field of view during the reading. Preferably, the array is a CCD or a CMOS array.

In accordance with this invention, an illuminator is mounted in the reader and illuminates the symbol during the reading with illumination light directed from an illumination light source along a folded optical path through the window to prevent illumination light at the window from being captured by the imager. The outgoing illumination light travels through the same area of the window as the incoming captured light travels to the imager. As previously described, such illumination light reflected from the window towards the imager creates areas or zones of high intensity light, i.e., hot spots, within the field of view of the imager. The illumination light source is preferably at least one LED, and each LED creates its own hot spot. Basically, each hot spot is a ghost image of a respective LED. In the prior art, these ghost images are superimposed over the image of the symbol and often compromise decoding and degrade reader performance.

In accordance with this invention, such hot spots are positioned outside of the field of view of the imager so that no ghost images are superimposed over the image of the symbol. In the preferred embodiment, each LED does not direct its light perpendicular to the plane of the window, but instead, directs its light at an angle of inclination toward a tilted fold mirror within the reader. Each fold mirror reflects the illumination light incident thereon toward the window. Any reflections off the window are not captured by the imager. Each fold mirror relocates a virtual image of a respective LED to a different location in space so that the respective ghost image is outside the field of view.

The novel features which are considered as characteristic of the invention are set forth in particular in the appended claims. The invention itself, however, both as to its construction and its method of operation, together with additional objects and advantages thereof; will be best understood from the following description of specific embodiments when read in connection with the accompanying drawings.

### BRIEF DESCRIPTION OF THE DRAWINGS

FIG. 1 is a perspective view of a point-of-transaction workstation operative for capturing light from symbol-bearing targets in accordance with this invention;

FIG. 2 is a perspective view of an electro-optical reader operative in either a hand-held mode, or a workstation mode, for capturing light from symbol-bearing targets in accordance with this invention;

FIG. 3 is a block diagram of various components of the workstation of FIG. 1;

FIG. 4 is a broken-away, top plan, diagrammatic view of various components in the workstation of FIG. 1 arranged in accordance with the prior art;

FIG. 5 is a schematic view of the field of view of the imager used in the prior art workstation of FIG. 4 with hot spots within the field of view;

FIG. 6 is a view analogous to FIG. 4 but with the components arranged in accordance with the invention; and

FIG. 7 is a view analogous to FIG. 5 wherein the hot spots are positioned outside the field of view of the imager in accordance with this invention.

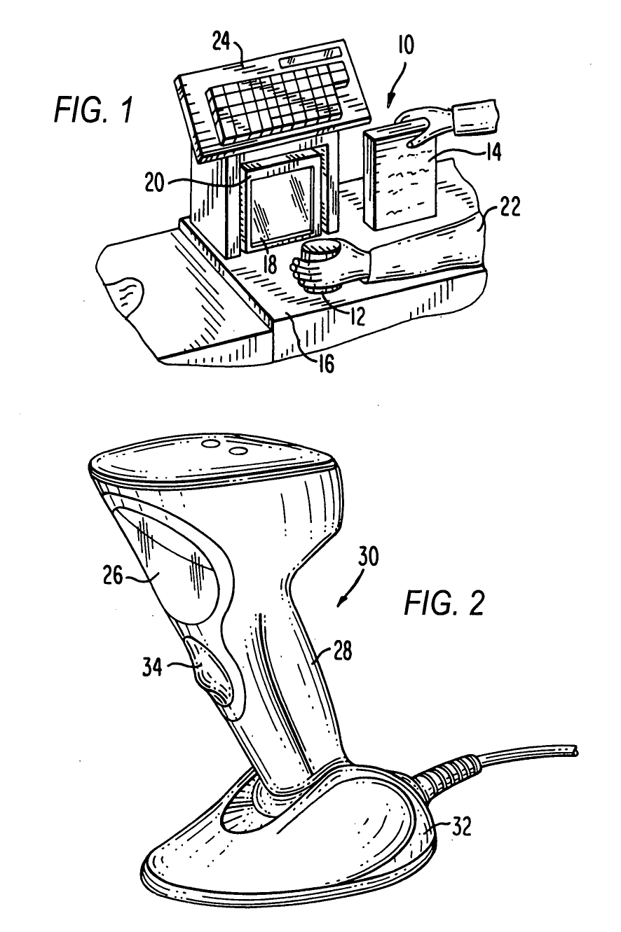

### DETAILED DESCRIPTION OF THE PREFERRED EMBODIMENTS

Reference numeral 10 in FIG. I generally identifies a workstation for processing transactions and specifically a checkout counter at a retail site at which products, such as a can 12 or a box 14, each bearing a target symbol, are processed for purchase. The counter includes a countertop 16 across which the products are slid at a swipe speed past a vertical planar window 18 of a box-shaped vertical slot reader 20 mounted on the countertop 16. A checkout clerk or operator 22 is located at one side of the countertop, and the reader 20 is located at the opposite side. A cash/credit register 24 is located within easy reach of the operator.

Reference numeral 30 in FIG. 2 generally identifies another reader having a different configuration from that of reader 20. Reader 30 also has a generally vertical window 26 and a gun-shaped housing 28 supported by a base 32 for supporting the reader 30 on a countertop. The reader 30 can thus be used as a stationary workstation in which products are slid or swiped past the vertical window 26, or can be picked up off the countertop and held in the operator's hand and used as a handheld reader in which a trigger 34 is manually depressed to initiate reading of the symbol.

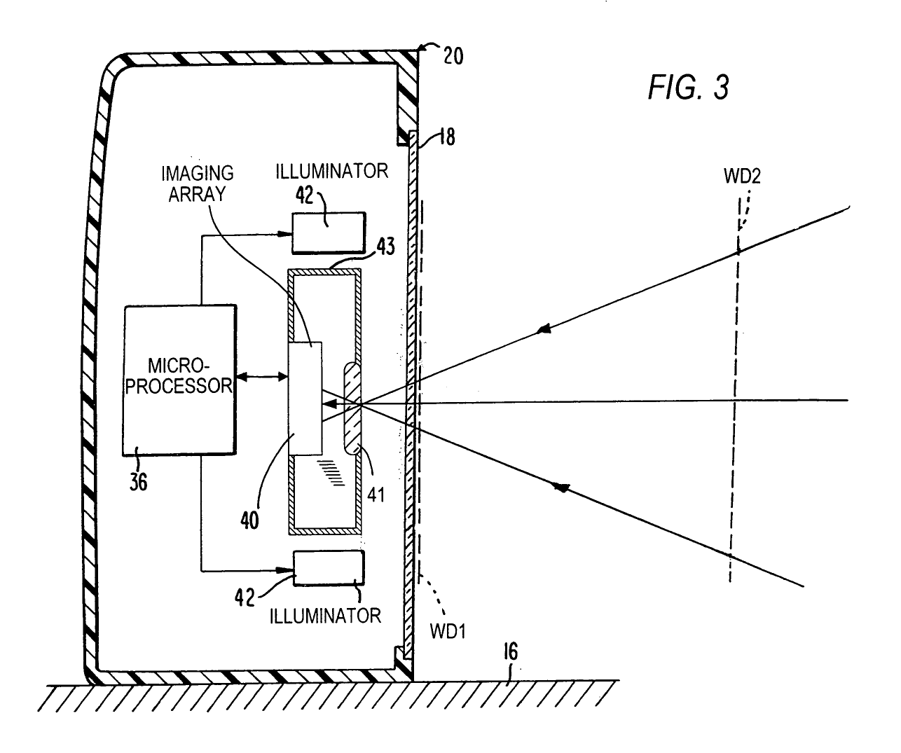

As described so far, the readers 20, 30 are conventional. As schematically shown in FIG. 3, an imager 40 and a focusing lens 41 are mounted in an enclosure 43 in either reader, such as the reader 20. The imager 40 is a solid-state device, for example, a CCD or a CMOS imager and has an array of addressable image sensors operative for capturing light through the window 18 from a target, for example, a one- or two-dimensional symbol, over a field of view and located in a working range of distances between a close-in working distance (WD1) and a far-out working distance (WD2). In a preferred embodiment, WD1 is about two inches from the imager array 40 and generally coincides with the window 18, and WD2 is about eight inches from the window 18. An illuminator is also mounted in the reader and preferably includes a plurality of light sources, e.g., light emitting diodes (LEDs) 42, arranged at opposite sides of the imager 40 to uniformly illuminate the target, as described below.

As shown in FIG. 3, the imager 40 and the illuminator LEDs 42 are operatively connected to a controller or microprocessor 36 operative for controlling the operation of these components. Preferably, the microprocessor is the same as the one used for decoding light scattered from the indicia and for processing the captured target images.

In operation, the microprocessor 36 sends a command signal to pulse the illuminator LEDs 42 for a short time period, say 500 microseconds or less, and energizes the imager 40 to collect light from a target symbol only during said time period. A typical array needs about 33 milliseconds to read the entire target image and operates at a frame rate of about 30 frames per second. The array may have on the order of one million addressable image sensors.

FIG. 4 is a schematic diagram, as seen in top plan view, of a reader in accordance with the prior art in which the illuminator LEDs 42 are positioned at opposite sides of an enclosure 43 containing the imager 40 and the imaging lens 41. Only two LEDs are shown to simplify the drawing. In practice, more LEDs may be used. Each illuminator LED 42 is a pseudo-point source and emits an illumination beam over a generally conical spatial volume whose central axis 50 is perpendicular to the plane of the window 18.

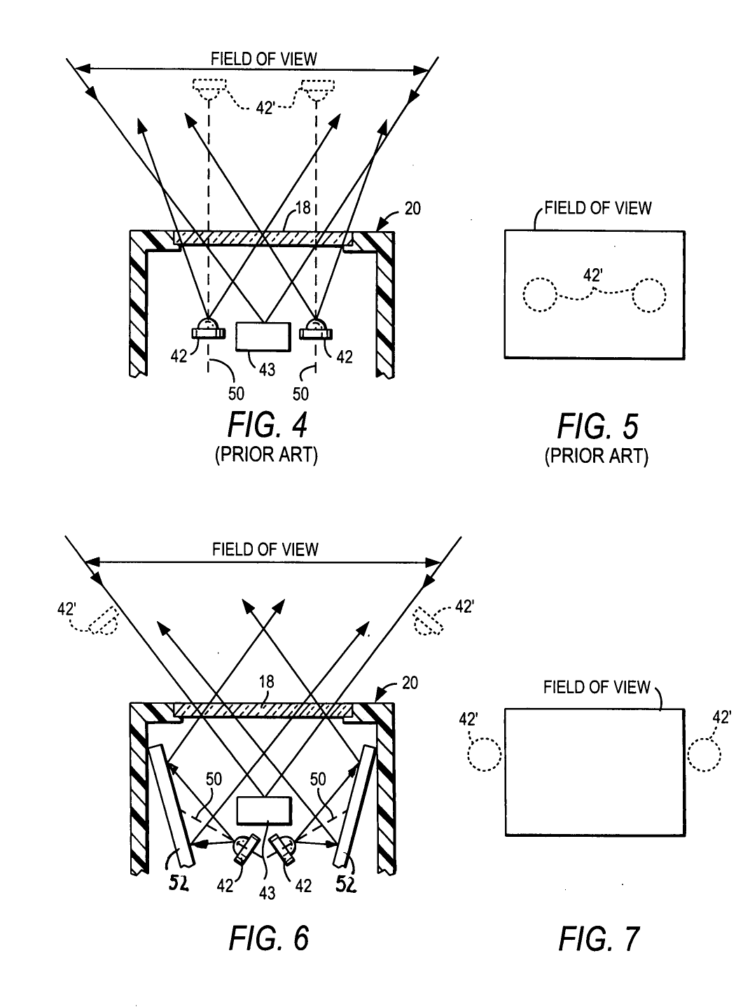

A portion of the illumination light from each LED reflects back from the window to the imager and, as previously described, creates a hot spot 42 in the field of view of the imager, as depicted in FIG. 5. This zone of intense light reflection is a ghost image that, if superimposed on the main image of the symbol, may prevent the main image from being decoded.

In accordance with this invention, such hot spots 42 are positioned outside of the field of view of the imager (see FIG. 7) so that no ghost images are superimposed over the image of the symbol. In the preferred embodiment, as shown in FIG. 6, each LED 42 is tilted and positioned so that its central axis 50 is not perpendicular to the plane of the window, but instead, is oriented at an angle of inclination toward fold mirrors 52, one for each LED, at opposite sides of the imager within the reader. Each fold mirror 52 is tilted and reflects the illumination light incident thereon toward the window. Any reflections off the window are not captured by the imager. Each fold mirror 52 relocates a virtual image of a respective LED 42 to a different location in space so that the respective ghost image is outside the field of view.

It will be understood that each of the elements described above, or two or more together, also may find a useful application in other types of constructions differing from the types described above. Thus, readers having different configurations can be used.

While the invention has been illustrated and described as an illuminator for illuminating a symbol without creating hot spots in a field of view of an imager in an imaging reader, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

1. A reader for electro-optically reading indicia, comprising:
a) a housing having a window;
b) a solid-state imager in the housing and including an array of image sensors for capturing light through an area of the window from the indicia over a field of view during reading; and
c) an illuminator in the housing for illuminating the indicia during reading with illumination light directed from an illuminating light source along a folded optical path through the same area of the window for reflection therefrom to prevent illumination light reflected from the window from being captured by the imager.

2. The reader of claim 1, wherein the illuminating light Source includes a light emitting diode (LED).

3. The reader of claim 1, wherein the illuminating light source includes a plurality of light emitting diodes (LEDs) at opposite sides of the imager.

4. The reader of claim 2, wherein the LED projects a conical volume of the illumination light having a central axis that intersects the window at an angle other than ninety degrees.

5. The reader of claim 2, wherein the illuminator includes a fold mirror for reflecting the illumination light from the LED to the window at an angle other than ninety degrees.

6. The reader of claim 3, wherein the illuminator includes a plurality of fold mirrors, one for each LED, for reflecting the illumination light from each LED to the window.

7. The reader of claim 6, wherein the fold mirrors are located at opposite sides of the imager.

8. The reader of claim 1, wherein the illuminator positions zones of the illumination light of high intensity outside the field of view of the imager.

9. The reader of claim 1, wherein the window is a planar, light-transmissive material.

10. The reader of claim 1, wherein the housing has a handle for handheld operation.

11. The reader of claim 1, wherein the housing has a base for supporting the housing on a support surface for workstation operation.

12. A reader for electro-optically reading indicia, comprising:
a) housing means having a window;
b) imaging means in the housing means including a solid-state imager having an array of image sensors for capturing light through an area of the window from the indicia over a field of view during reading; and
c) illuminator means in the housing means for illuminating the indicia during reading with illumination light directed from an illuminating light source along a folded optical path through the same area of the window for reflection therefrom to prevent illumination light reflected from the window from being captured by the imager.

13. A method of electro-optically reading indicia, comprising the steps of:
a) capturing light through an area of a window of a reader from the indicia over a field of view during reading by an array of image sensors of a solid-state imager; and
b) illuminating the indicia during reading with illumination light directed from an illuminating light source along a folded optical path through the same area of the window for reflection therefrom to prevent illumination light reflected from the window from being captured by the imager.

14. The method of claim 13, wherein the illuminating step is performed by projecting the illumination light as a conical volume having a central axis that intersects the window at an angle other than ninety degrees.

15. The method of claim 13, wherein the illuminating step is performed by reflecting the illumination light from the LED to the window.

16. The method of claim 13, wherein the illuminating step is performed by positioning zones of the illumination light of high intensity outside the field of view of the imager.

17. The method of claim 13, wherein the illuminating step is performed by positioning fold mirrors at opposite sides of the imager.

18. The method of claim 13, and configuring the window of a planar, light-transmissive material.

19. The method of claim 13, and the step of holding the reader by a handle for handheld operation.

20. The method of claim 13, and the step of supporting the reader on a support surface for workstation operation.
